(19) United States
(12) Patent Application Publication
(10) Pub. No.: US 2023/0186447 A1
(43) Pub. Date: Jun. 15, 2023

(54) EFFICIENT FOCUS STACKING FOR LARGE IMAGES OF PALYNOLOGICAL SAMPLES

(71) Applicant: SAUDI ARABIAN OIL COMPANY, Dhahran (SA)

(72) Inventors: Mustafa Ali H. Al Ibrahim, Safwa (SA); Mokhles M. Mezghani, Dhahran (SA)

(73) Assignee: SAUDI ARABIAN OIL COMPANY, Dhahran (SA)

(21) Appl. No.: 17/643,458

(22) Filed: Dec. 9, 2021

(51) Int. Cl. G06T 5/50; G06T 7/00; G06T 7/37; G06T 5/20

(52) U.S. Cl. CPC G06T 5/50; G06T 7/001; G06T 7/37; G06T 5/20; G06T 2207/10148; G06T 2207/20221

(57) ABSTRACT

A method of creating a focused image of a sample includes: acquiring a first image of the sample at a first height of a focal plane; acquiring a second image of the sample at a second height of the focal plane; creating a mask from the first image; calculating a first metric for a first pixel in the first image, wherein the first pixel is not covered by the mask; calculating a second metric for a second pixel in the second image, wherein the second pixel is not covered by the mask; and constructing the focused image of the sample from data of the first pixel and data of the second pixel based on the first metric and the second metric.

### BACKGROUND

Palynological analysis involves examining a sample that contains observation targets under a microscope in detail. High-resolution thin section scanners provide a way to digitize a whole image of a sample to be accessed and utilized on-demand. Unfortunately, using a lens with high magnification yields a small focal depth. Thus, a small (sub-micron) variation in sample thickness or surface roughness of an observation target often puts the observation target out of the focal depth and results in unfocused images. This can affect identification of the observation target and consequently interpretation of the sample.

Furthermore, an image obtained by high-resolution thin section scanners may contain multiple observation targets. Even when one observation target is in focus, other observation targets may be out of focus. Therefore, an image may be divided into smaller sub-images, called tiles, and an image of the best focus may be obtained by stitching sub-images of good foci together.

In view of the above, focus stacking can be used to obtain a focused image.

Focus stacking (or multi-focus image fusion) is the term used to describe a number of methods that utilize a number of images that are partly out of focus to obtain one merged image with an optimal focus. Multiple images are taken at different heights of the focal plane (or at different focal planes) and they are merged to produce one composite focused image. Most implementations that are practically used for the focus stacking are automated using image processing algorithms.

In terms of the timing of analysis of images with respect to their acquisitions, there are two different major approaches that yield autofocused images with focus stacking: 1) online (real-time, or active) auto-focusing of tiles during acquisition, and 2) passive autofocusing as a process performed after acquisition.

Active auto-focusing attempts to focus an image during acquisition. In each location/tile in the entire view of a sample, the best focused plane is determined by an algorithm based on a specific metric and the microscope is automatically adjusted by software. For each tile, an image is acquired at the best focused plane and saved. Then, resultant images are merged into an image containing all of the focused tiles. Passive auto-focusing reconstructs a focused image after acquiring a number of images of the whole sample at different focal planes. A microscope can be set to obtain multiple images at different focal planes manually or automatically. Post processing algorithms based on a specific metric are then used to combine these images into one focused image.

The above-described major approaches, namely the active auto-focusing and the passive auto-focusing, are not exclusive with each other and they may be combined together. Generally, a degree in how much of one approach can be adopted rather than the other depends on a number of factors: 1) the capabilities of the microscope and the acquisition software, 2) acquisition time taken by the two approaches, and 3) availability of storage of image data and data processing resources. In more specific examples, active auto-focusing requires a motorized microscope with a controllable focal depth adjuster while passive auto-focusing does not. Depending on the microscope hardware capabilities, sequential focal plane adjustment for each tile in the image may be time-consuming compared to obtaining a full set of sample images at different focal planes. Passive auto-focusing requires the storage of multiple images of the same sample but at different focal planes which require storage for images by a factor of the number of focal planes whereas active auto-focusing requires storage that stores only a final image. Furthermore, because passive auto-focusing involves acquisitions of multiple images of a sample at multiple focal planes, it may enable other usage scenarios such as constructing a three-dimensional image of the sample.

In either approach (or their combination), given m images obtained at different focal planes, fᵢ, where 1≤i≤m, the best focused image needs to be found for each pixel. Once the best focused pixels are known with some metric, then one image constituting these best focused pixels is assembled. Because palynological sample analysis typically requires acquisition of high-resolution images of about 300,000,000 pixels per sample, efficiency in calculating metrics for a degree of focusing for each pixel becomes very important.

### SUMMARY

According to one or more embodiments of the present invention, a method of creating a focused image of a sample includes: acquiring a first image of the sample at a first height of a focal plane; acquiring a second image of the sample at a second height of the focal plane; creating a mask from the first image; calculating a first metric for a first pixel in the first image, wherein the first pixel is not covered by the mask; calculating a second metric for a second pixel in the second image, wherein the second pixel is not covered by the mask; and constructing the focused image of the sample from data of the first pixel and data of the second pixel based on the first metric and the second metric.

Further, according to one or more embodiments of the present invention, a non-transitory computer readable medium stores instructions executable by a computer processor, and the instructions includes functionality for: acquiring a first image of a sample at a first height of a focal plane; acquiring a second image of the sample at a second height of the focal plane; creating a mask from the first image; calculating a first metric for a first pixel in the first image, wherein the first pixel is not covered by the mask; calculating a second metric for a second pixel in the second image, wherein the second pixel is not covered by the mask; and constructing a focused image of the sample from data of the first pixel and data of the second pixel based on the first metric and the second metric.

### BRIEF DESCRIPTION OF DRAWINGS

The following is a description of the figures in the accompanying drawings. In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1A shows an example of a palynological sample (slide) image and FIGS. 1B and 1C show enlarged views of sections of the image shown in FIG. 1A.

FIG. 2 shows a flowchart describing a method of focus stacking in accordance with one or more embodiments.

FIG. 3 shows a flowchart describing sub steps in a step of acquiring image stacks of a sample at different focal planes in accordance with one or more embodiments.

FIG. 4 shows a flowchart describing sub steps in a step of identifying background in an image of a sample in accordance with one or more embodiments.

FIG. 5 shows a flowchart describing sub steps in a step of creating a mask for an image of a sample in accordance with one or more embodiments.

FIGS. 6A-6D show schematic diagrams describing sub steps in a step of creating a mask for an image of a sample in accordance with one or more embodiments.

FIG. 7 shows schematic diagrams describing convolution calculation to obtain metric values for pixels in a view in according with one or more embodiments.

FIGS. 8A-8C show schematic diagrams describing focus metric calculation using a finite-size kernel and a mask in accordance with one or more embodiments.

FIG. 9 shows a computing device in accordance with one or more embodiments.

### DETAILED DESCRIPTION

In the following detailed description, certain specific details are set forth in order to provide a thorough understanding of various disclosed implementations and embodiments. However, one skilled in the relevant art will recognize that implementations and embodiments may be practiced without one or more of these specific details, or with other methods, components, materials, and so forth. In other instances, well known features or processes have not been shown or described in detail to avoid unnecessarily obscuring descriptions of the implementations and embodiments. For the sake of continuity, and in the interest of conciseness, same or similar reference characters may be used for same or similar objects in multiple figures.

Embodiments disclosed herein relate to a novel algorithm for efficient focus stacking for palynological sample images. Focus stacking is a process where multiple images at the same location with different focal planes are merged together to obtain one composite image that has the optimum focus. The result is focused/sharp palynological sample images which lead to better interpretation. The algorithm described herein uses the fact that most area in palynological sample images is background and thus can be effectively ignored. This can result in decrease in processing time to up to 50% depending on the amount of background in the image without any loss in quality of the results.

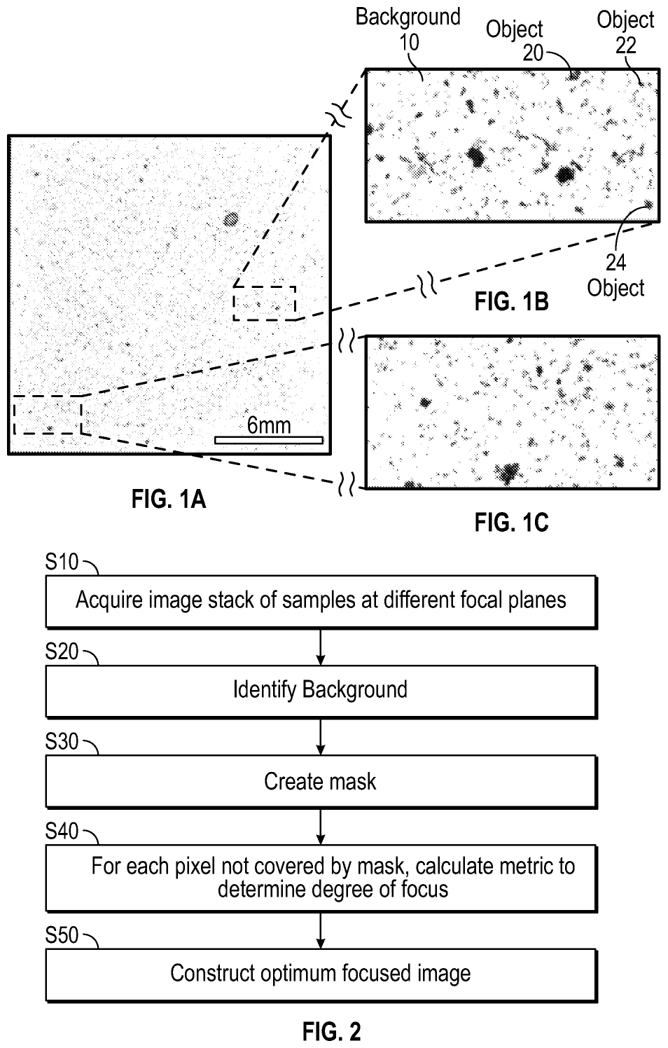

FIG. 1A shows an example of a palynological sample (slide) image. Palynological samples/slides may be made for organic material that may be extracted from rock fragments. The extraction involves a number of steps including breaking up large rock fragments into smaller ones, dissolution of other rock components by acids, then extraction of organic matters by centrifuges. The residual organic matters are inserted into a glass thin section slide and imaged. High resolution images that covers the whole sample are then obtained using a thin section scanner.

Images of palynological samples such as that shown in FIG. 1A may be acquired at multiple focal planes and the images can be used to obtain one merged image with an optimal focus.

The size of a pixel of the image shown in FIG. 1A may be equivalent to 110 nanometer at 40× magnification and the number of pixels in the image may become more than 25 billion to capture the entirety of a sample.

FIGS. 1B and 1C show enlarged views of sections of the image shown in FIG. 1A. As shown in FIGS. 1B and 1C, a typical palynological sample image is composed mostly from background (10), which is almost white if the image is taken in color, and the portion of the area of the image occupied by objects (20, 22, 24) may be as small as 10%. Objects (20, 22, 24) in the image are organic matters to be observed in further analysis. Other artifacts such as a position marker placed by a palynologist may be seen in the image (as shown in FIG. 1A). There is a large contrast between the background (10) and the objects (20, 22, 24).

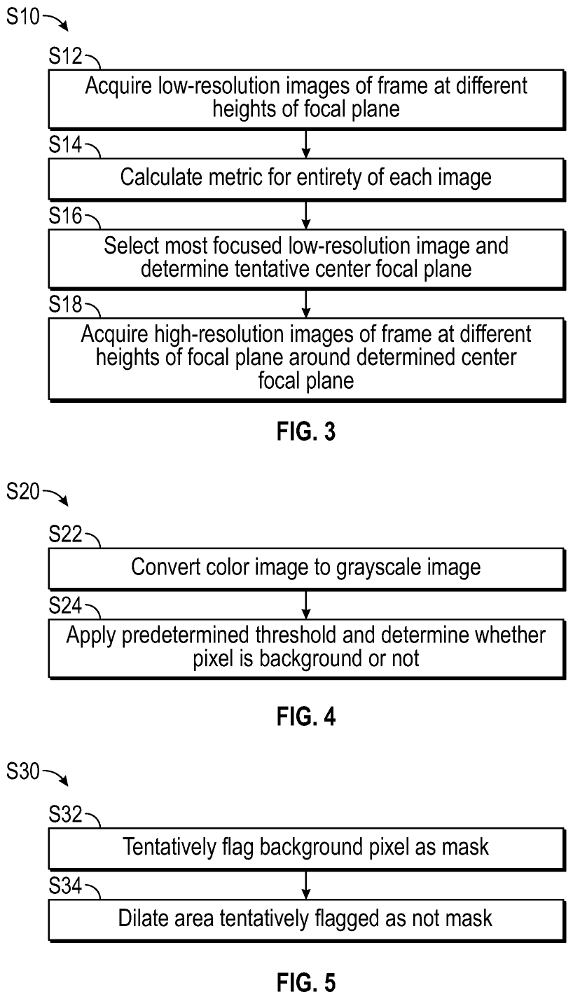

FIG. 2 shows a flowchart that describes general steps of workflow of focus stacking in accordance with one or more embodiments. The general steps of the workflow are: 1) acquisition of an image stack of a sample at the same location at different focal planes (S10); 2) identification of background (S20); 3) creation of a mask (S30); 4) calculation of a metric value (i.e., focus measurement using the metric) for each pixel that is not covered by the mask (S40); and 5) construction of an optimum focused image based on the calculated metric values (S50). Hereafter, more details of each step are described in FIGS. 3-5.

FIG. 3 shows a flowchart that describes sub steps in the step of acquisition of an image stack (i.e., a plurality of images) (S10 of FIG. 2) of a sample at the same location at different focal planes in accordance with one or more embodiments. Initially, low-resolution images (with low magnification lens) are obtained for the sample at different focal planes (i.e., at different heights of the focal plane) (S12). Then, for each low-resolution image, a metric is calculated that yields a degree of focusing of the image (S14). The metric may be calculated for the entirety of the image, as shown in FIG. 3. Alternatively, one object seen in the images may be selected (which could be of the highest interest in the image for further analysis) and the metric may be calculated for the selected object (or for a region defined over and around the selected object). The metric used for this step S14 may be the same metric used in the focus stacking described later as S40, or may be different. For example, when the metric used for this step S14 is the same metric used in the focus stacking described later as S40, metric values may be calculated for all low-resolution pixels in one image and an average of the calculated metric values may be assigned to a metric value of the entire image.

Once metric values are calculated for all low-resolution images (or for the object/region in the images), the metric values are compared and the focal plane of the image with the best metric is considered as the (tentative) center focal plane (S16).

Next, multiple high-resolution images around the center focal plane are obtained with a small interval (i.e., step) that is separately defined (S18). The size of the step may depend on 1) the thickness of the sample, 2) the amount of time available for acquisition and processing of high-resolution images, and 3) the amount of storage available for image data.

The above described low-resolution images and high-resolution images may be obtained manually or automatically using a thin section scanner.

Acquisition of multiple images at different focal planes may be improved in a number of methods. For example, the low-resolution images at different heights of the focal plane can be used to minimize the range of the height of the focal plane that contains useful information in the sample images and to reduce the number of high-resolution images (and consequently, to reduce the time required to obtain high-resolution images). A special lens that changes the focal plane in response to an acoustic signal may be used to rapidly move the focal plane and obtain the images.

The high-resolution images that are acquired in step S10 are processed to construct an optimum focused image. First, in step S20 of FIG. 2, background is identified in at least one of the high-resolution images in one or more embodiments. For example, the high-resolution image acquired for the center focal plane may be used to identify background. Then, the same background information may be used to all other high-resolution images. Alternatively, background may be identified for all (or some portions) of the high-resolution images independently, which may not be as efficient as using only one image for background identification.

Background can be identified through color or grayscale thresholding. Namely, when the high-resolution images are obtained in color, thresholds can be applied in the commonly known RGB (red, green, and blue) color space or any other color space such as HSV (hue, saturation, and value). Alternatively, a set of predefined range for each channel (R, G, or B for RGB color space, or H, S, or for HSV color space) in the image may be used. When the high-resolution images are obtained in black-and-white (or in grayscale), grayscale thresholding may be used.

Further, even when the high-resolution images are obtained in color, the color image used for background identification may be first converted to a grayscale image (S22), as shown in FIG. 4, and grayscale thresholding may be used for background identification (S24). This selection of grayscale thresholding for high-resolution color images may be chosen because 1) identification of almost white background is a simple task and it does not require utilization for all color channels and/or 2) it cuts the processing time for the thresholding operation by about two thirds when compared using full color information.

The conversion from color images to grayscale images can be done using a number of methods. In one or more embodiments, a gray scale pixel value P_{gray} may be calculated as P_{gray}=0.2989×Pᵣ+0.5870×P_{g}+0.1140×P_{b} where Pᵣ, P_{g}, and P_{b} correspond to the pixel values of red, green, and blue components, respectively.

It should be noted that grayscale pixel values of all pixels in the images may be used for further calculation of focus metric values. Accordingly, conversion of color images to grayscale images may be performed to all high-resolution color images and resultant grayscale images may be stored for subsequent steps.

Thresholding is then applied to the calculated grayscale pixel values. In one or more embodiments, automated thresholding can be used to determine the optimum threshold value. Furthermore, semantic segmentation neural networks can be trained to identify the background. Practically, this may not be needed because the objects and the background may show high contrast with respect to each other and the background may be easily distinguishable. Further, the threshold for differentiating the background and the objects may be relatively constant in all the images analyzed and, thus, in one or more embodiments, a predefined thresholding cutoff may be set manually (S24). Further, the predefined value may be used for various samples.

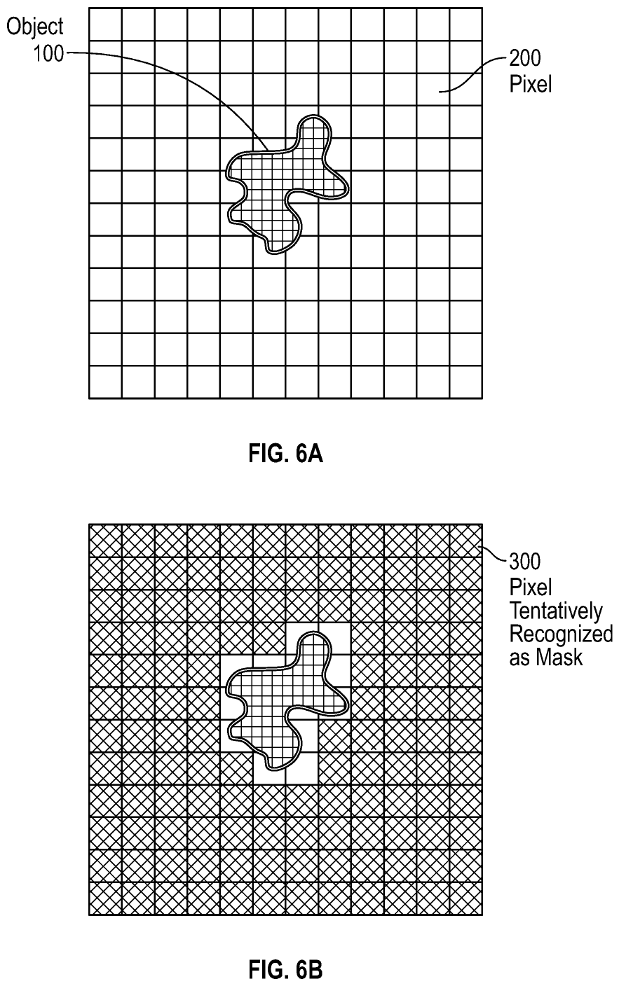

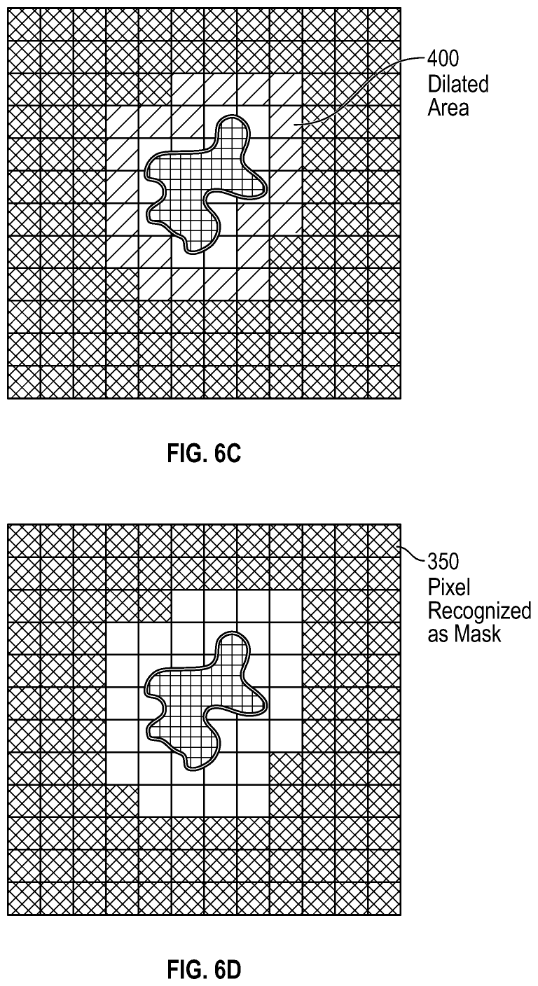

After background is identified in the high-resolution images, a mask used for focus metric calculation is created (S30 in FIG. 2). FIG. 5 shows a flowchart describing sub steps in the step of creating a mask in accordance with one or more embodiments. The sub steps are described below with reference to sample schematic diagrams shown in FIGS. 6A-6D.

First, the pixels identified as the background are flagged as tentative mask pixels (S32). Operation of this sub step S32 may be explained using FIGS. 6A and 6B. The field of view shown in FIG. 6A includes a 16×16 matrix of pixels (200) shown as small squares and one object (100, drawn with a curved boundary) is located near the center of the field. In the step of background identification, all of the pixels that do not include any part of the object (100) are identified as background. Then, as shown in FIG. 6B, after the sub step S32, all those pixels that are identified as background are flagged as pixels tentatively recognized as a mask (300). Namely, the pixels that the object (100) occupies (or the area NOT tentatively flagged as a mask) may be considered as a “hole” in the mask.

Then, the “hole” in the mask is dilated (S34). This operation is performed to ensure that an optimum focus is obtained. The dilation may be achieved as “binary” dilation operation and the mask may be expanded by a few to several pixels around organic matters in images. For example, the “hole” in the mask may be dilated by 5 pixels. However, dilation with a smaller number of pixels may leave a large mask and improve efficiency in further calculation. FIG. 6C shows an example of binary dilation operation that expands (or dilates) the “hole” in the mask by one pixel and an area to be dilated (400) is determined. The created mask in the example of FIG. 6C is shown in FIG. 6D. In FIG. 6D, the hatched pixels (350) form the final mask, which is used for further calculation.

Next, metric values (i.e., “focus measures”) are calculated and degrees of focus are determined for each pixel in respective images of the image stack (S40). Focus measures used for this application may need to satisfy three conditions explained below.

Firstly, they should reflect the local focus of the image.

Secondly, they may be calculated locally to allow parallelization. The ability to deal with very large size images (i.e., large fields of view and/or high resolutions) may be improved by using a distributed computing implementation, which allows for automatic scaling on multiple nodes in a cluster. All the steps in the workflow may be applied on sub-images in parallel and the results of sub-images may be assembled together to yield a resultant image.

Thirdly, they should be computationally inexpensive. For example, they may need to be obtained in a limited number of convolutional passes (ideally one) for fast performance.

Most focus measures known to the art may be formulated to follow the above three conditions with proper implementation. One example is application of a finite-size (n×n) kernel matrix to an image matrix, as explained below.

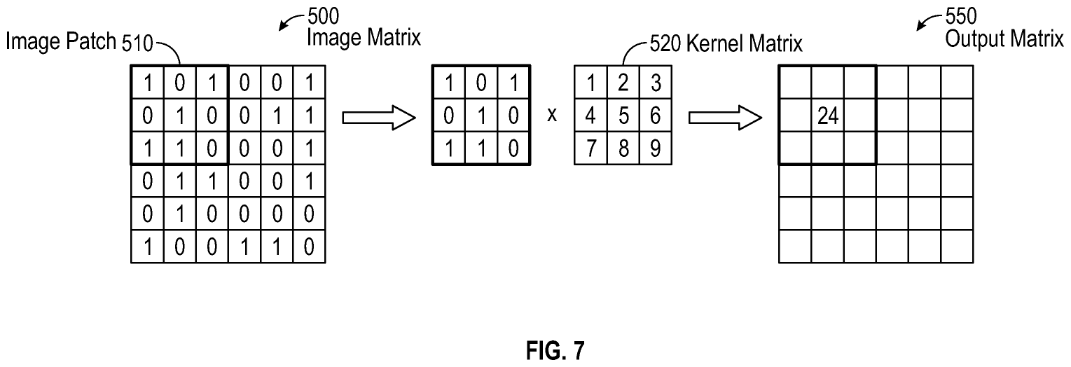

As shown in FIG. 7, given an image matrix (500) that is larger than a kernel matrix (520), an image patch (510) of the size of the kernel matrix (520) is extracted from the image matrix (500). In the example of FIG. 7, the image matrix (500) has a size of 6×6 and the image patch (510) of a size of 3×3 is extracted because the kernel matrix (520) has a size of 3×3. The kernel matrix (520) is overlapped with the image patch (510) and values of image pixels in the image patch (510) are multiplied by corresponding values in the kernel matrix (520), and the products are summed. In the example of FIG. 7, 1×1+0×2+1×3+0×4+1×5+0×6+1×7+1×8+0×9 is performed and the sum of 9 products is calculated to be 24. Then, the summation result “24” is stored at the location corresponding to the center of the image patch (510) in an output matrix (550) that has the same size (in the example of FIG. 7, 6×6) as the image matrix (500). The above calculation is done for each pixel in the image. It may be noted that some cells in the output matrix (550) are not filled with values depending on the size of the kernel matrix (520). The unfilled cells in the output matrix (550) may be left blank (or marked as unfilled) or padded to maintain the size of the matrix from the input image (500) to the output image (550). The padding may be done with all zeros or may have multiple values (e.g., replicate nearest pixel values).

The size of the kernel matrix (520) may depend on the resolution of the images whereas the cell values of the kernel matrix (520) may be determined based on a type of the focus metric. In one or more embodiments, a Laplacian-of-Gaussian (LoG) kernel is used as the focus metric, as described in the following equation:

$$LoG ( u , v ) = \frac{1}{π {σ}^{4}} ( \frac{{u}^{2} + {v}^{2}}{2 {σ}^{2}} - 1 ) {e}^{- \frac{{u}^{2} + {v}^{2}}{2 {σ}^{2}}}$$

where u and v are distances in x and y coordinates in an image measured from the center of the kernel matrix (520) and a is a standard deviation. The above equation yields a Laplacian of Gaussian with negative polarity. In one or more embodiments, a 100×100 matrix with the standard deviation of 20 (pixels) may be used.

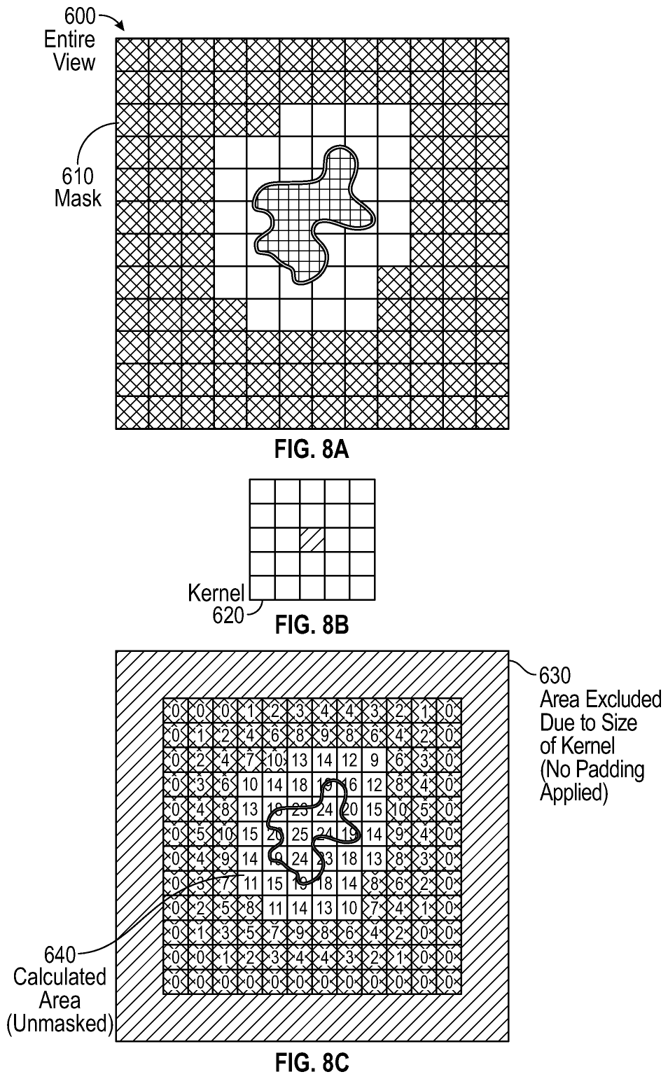

Efficiency of the aforementioned calculation of metrics (i.e., full convolution) may be improved by using a mask (i.e., masked convolution). For masked convolution, the calculation procedures described above are simplified using the mask. An example of application of a mask is explained below with reference to FIGS. 8A-8C.

FIG. 8A shows an input image with a field of view (600) of 16×16 pixels with an object at the center. Out of 16×16 pixels, many pixels are recognized as being covered by a mask (610). FIG. 8B shows a kernel matrix (620) to be used for calculation in this example. The kernel matrix (620) has a size of 5×5 pixels. Consequently, in this example, if the full convolution is used, the total of 25 cells of each image patch are multiplied by values of the kernel matrix (620) and summed together to yield one pixel value in an output image matrix. The kernel matrix (620) can be applied to image patches that cannot extend beyond an edge of the input image and many pixels in the output image shown in FIG. 8C near the edges are excluded in analysis. The size of the excluded area (630) depends on the size of the kernel matrix (620). In this example, the width of this excluded area (630) is 2 pixels.

When the image patch is located inside the input image, pixels covered by the mask (610) may be ignored in convolution calculation. Namely, although the kernel matrix (620) contains 25 cells, multiplication of the kernel values and pixel values in an image patch may be needed only for the pixels not covered by the mask (610). The values shown in FIG. 8C show the numbers of multiplications performed to obtain pixel values of the output image matrix. For this specific example, there is only one pixel with the value “25” that is located near the center of the output image matrix. Namely, only one pixel requires full 25 multiplications to obtain the pixel value and, for the rest of the pixels, full 25 multiplications are not required. On the contrary, there are many pixels that show “0,” which means no multiplications are required. Therefore, compared to the full convolution in which full 25 multiplications are performed for the entire field of view (600) except the area excluded due to the size of the kernel matrix (630), calculation steps are omitted and improvement in efficiency is obtained.

Alternatively, with a different use of the mask (610), the calculation efficiency may be further improved. In one or more embodiments, the convolution calculation may be performed only for the pixels not covered by the mask (610). In this case, the calculations (not only multiplications, but also summation) may be performed only for the pixels in the unmasked area (640) and further improvement in calculation efficiency is obtained.

After focus metric values are calculated for all images of the image stack, an optimum focused image is constructed (S50). For each location of the sample image, focus metric values of the corresponding pixels in all the images of the image stack are compared and the best focus metric value is determined. The image that yields the best focus metric value contains the best (most focused) pixel information of the location. Therefore, the pixel information in the image that yields the best focus metric value in the image stack should be selected to construct the corresponding pixel of the optimum focused image. The above determination and selection is repeated for all pixels in the images and the optimum focused image is constructed.

In one or more embodiments in which the above-described Laplacian of Gaussian with negative polarity is used, the greater the focus metric value is, the more focused the pixel is. Therefore, a maximization function is used to select the most focused pixel.

At locations where no focus metric value is calculated in any of the images of the image stack, a background color such as white may be assigned for construction of the optimum focused image. This white background assignment may be useful to simplify the constructed optimum image for further analysis such as use of neural networks to automatically detect machine specific palynomorphs. In one or more embodiments, the background of the center focal plane may be used if more realistic background is desired (assuming that the center focal plane has a relatively good focus metric value).

To obtain a confidence in the result, indices of the selected images for the optimum image construction may be used. Namely, if pixel information is chosen from the images corresponding to the first or the last layer in the image stack, there is a possibility of obtaining better results by obtaining images at different heights of the focal plane that are outside of the range associated with the image stack. The possibility may be visually indicated to the user via an output device of a computer system, as described below.

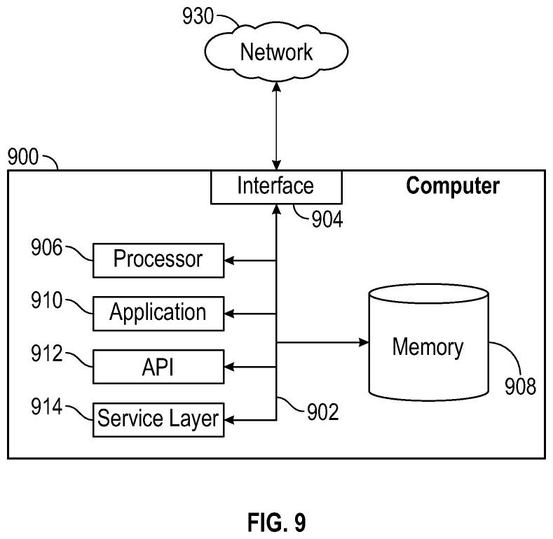

Above-described embodiments may be implemented on any suitable computing device, such as for example a computer system. FIG. 9 is a block diagram of a computer system (900) used to provide computational functionalities associated with described algorithms, methods, functions, processes, flows, and procedures as described in the instant disclosure, according to an implementation. The illustrated computer (900) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (900) may include a computer that includes an input device, such as a keypad, keyboard, touch screen, or other device that can accept user information, and an output device that conveys information associated with the operation of the computer (900), including digital data, visual, or audio information (or a combination of information), or a GUI.

The computer (900) can serve in a role as a client, network component, a server, a database or other persistency, or any other component (or a combination of roles) of a computer system for performing the subject matter described in the instant disclosure. The illustrated computer (900) is communicably coupled with a network (930). In some implementations, one or more components of the computer (900) may be configured to operate within environments, including cloud-computing-based, local, global, or other environment (or a combination of environments).

At a high level, the computer (900) is an electronic computing device operable to receive, transmit, process, store, or manage data and information associated with the described subject matter. According to some implementations, the computer (900) may also include or be communicably coupled with an application server, e-mail server, web server, caching server, streaming data server, business intelligence (BI) server, or other server (or a combination of servers).

The computer (900) can receive requests over network (930) from a client application (for example, executing on another computer (900)) and responding to the received requests by processing the said requests in an appropriate software application. In addition, requests may also be sent to the computer (900) from internal users (for example, from a command console or by other appropriate access method), external or third-parties, other automated applications, as well as any other appropriate entities, individuals, systems, or computers.

Each of the components of the computer (900) can communicate using a system bus (902). In some implementations, any or all of the components of the computer (900), both hardware or software (or a combination of hardware and software), may interface with each other or the interface (904) (or a combination of both) over the system bus (902) using an application programming interface (API) (912) or a service layer (914) (or a combination of the API (912) and service layer (914)). The API (912) may include specifications for routines, data structures, and object classes. The API (912) may be either computer-language independent or dependent and refer to a complete interface, a single function, or even a set of APIs. The service layer (914) provides software services to the computer (900) or other components (whether or not illustrated) that are communicably coupled to the computer (900). The functionality of the computer (900) may be accessible for all service consumers using this service layer. Software services, such as those provided by the service layer (914), provide reusable, defined business functionalities through a defined interface. For example, the interface may be software written in JAVA, C++, or other suitable language providing data in extensible markup language (XML) format or other suitable format. While illustrated as an integrated component of the computer (900), alternative implementations may illustrate the API (912) or the service layer (914) as stand-alone components in relation to other components of the computer (900) or other components (whether or not illustrated) that are communicably coupled to the computer (900). Moreover, any or all parts of the API (912) or the service layer (914) may be implemented as child or sub-modules of another software module, enterprise application, or hardware module without departing from the scope of this disclosure.

Improvement in calculation efficiency described above may depend on respective calculation techniques implemented in the computer (900) and software language. For example, calculations performed on a 1,024×1,024 randomly generated input image with 80% background with a 9×9 randomly generated kernel matrix yield average calculation times of 82.6 ms to 1.67 s, as shown in the table below. The results shown here are averaged over 7 runs.

| | | | Percentage time | |
|---|---|---|---|---|
| | | | compared to | |
| | Average | Standard | reference | |
| Method | time | deviation | (lower is better) | Notes |
| Full convolution | 1.67 s | 114 ms | 13.14 | Used the standard Python |
| using Direct/ | | | | package scipy which uses C |
| overlap method | | | | and FORTRAN codes to |
| using Scipy | | | | perform linear algebra |
| | | | | operations |
| Full convolution | 127 ms | 6.57 ms | 1 | Used the standard Python |
| using fast fourier | | | | package scipy which uses |
| transform (FFT) | | | | numpy. The underlying |
| using Scipy | | | | implementation of numpy |
| | | | | is C and FORTRAN codes to |
| | | | | perform linear algebra |
| | | | | operations |
| Masked | 82.6 ms | 3.34 ms | .65 | Used the standard Python |
| convolution | | | | package numpy with |
| implementation | | | | masked convolution |
| implemented in | | | | implemented in Cython. |
| one or more | | | | |
| embodiments | | | | |

The first two implementations are considered standard for scientific computing in Python. The FFT (fast fourier transform) method (shown as the second in the table) generally shows a better performance for large images compared to the direct overlap method (shown as the first in the table). Still, the FFT method does not yield fast calculation matching the masked convolution implementation (shown as the third in the table).

When the background percentage or the image size is increased, the percentage time compared to the reference (full convolution using FFT shown as the second in the table) decreases, which means better performance. For example, for an image of a size of 4,096×4,096 with 80% background, the percentage time is 0.59 and, for an image of a size of 8,192×8,192 with 80% background, the percentage time further reduces to 0.52. A typical example size of a palynological sample is 171,822×171,822 and a further noticeable gain in efficiency is expected.

There is a small overhead when running Cython as compared to C/C++. The Cython compiler compiles python codes to C. Because it is an automatic compiler, writing performant code directly in C by an expert generally yields more efficient results. However, there have been lots of improvement in Cython compilation and computation time using Cython becomes closer to the case where C is used and improvement by writing the code directly in C is expected to be as small as about 5%.

The computer (900) includes an interface (904). Although illustrated as a single interface (904) in FIG. 9, two or more interfaces (904) may be used according to particular needs, desires, or particular implementations of the computer (900). The interface (904) is used by the computer (900) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (900).

The computer (900) includes at least one computer processor (906). Although illustrated as a single computer processor (906) in FIG. 9, two or more processors may be used according to particular needs, desires, or particular implementations of the computer (900). Generally, the computer processor (906) executes instructions and manipulates data to perform the operations of the computer (900) and any algorithms, methods, functions, processes, flows, and procedures as described in the instant disclosure.

The computer (900) also includes a memory (908) that holds data for the computer (900) or other components (or a combination of both) that can be connected to the network (930). For example, memory (908) can be a database storing data consistent with this disclosure. Although illustrated as a single memory (908) in FIG. 9, two or more memories may be used according to particular needs, desires, or particular implementations of the computer (900) and the described functionality. While memory (908) is illustrated as an integral component of the computer (900), in alternative implementations, memory (908) can be external to the computer (900).

The application (910) is an algorithmic software engine providing functionality according to particular needs, desires, or particular implementations of the computer (900), particularly with respect to functionality described in this disclosure. For example, application (910) can serve as one or more components, modules, applications, etc. Further, although illustrated as a single application (910), the application (910) may be implemented as multiple applications (910) on the computer (900). In addition, although illustrated as integral to the computer (900), in alternative implementations, the application (910) can be external to the computer (900).

There may be any number of computers (900) associated with, or external to, a computer system containing computer (900), each computer (900) communicating over network (930). Further, the term “client,” “user,” and other appropriate terminology may be used interchangeably as appropriate without departing from the scope of this disclosure. Moreover, this disclosure contemplates that many users may use one computer (900), or that one user may use multiple computers (900).

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed is:

1. A method of creating a focused image of a sample, the method comprising:
acquiring a first image of the sample at a first height of a focal plane;
acquiring a second image of the sample at a second height of the focal plane;
creating a mask from the first image;
calculating a first metric for a first pixel in the first image, wherein the first pixel is not covered by the mask;
calculating a second metric for a second pixel in the second image, wherein the second pixel is not covered by the mask; and
constructing the focused image of the sample from data of the first pixel and data of the second pixel based on the first metric and the second metric.

2. The method according to claim 1, further comprising:
acquiring a plurality of tentative images with a resolution lower that a resolution of either one of the first and second images;
calculating metrics for entireties of the plurality of tentative images; and
selecting the first and second heights based on the metrics.

3. The method according to claim 1, wherein the creating the mask comprises:
identifying pixels that correspond to an area that is out of interest; and
flagging positions of the identified pixels as positions covered by the mask.

4. The method according to claim 3, wherein the area that is out of interest is a background.

5. The method according to claim 1, wherein
the first metric is a first value of Laplacian of Gaussian (LoG) kernel for the first pixel, and
the second metric is a second value of LoG kernel for the second pixel.

6. The method according to claim 1, wherein the first metric is calculated by accounting only pixels that are in the first image and that are not covered by the mask.

7. The method according to claim 1, wherein the constructing the focused image comprises:
collecting data for each pixel of the focused image from the first and second images.

8. The method according to claim 7, wherein
the first pixel in the first image corresponds to the second pixel in the second image,
a third pixel of the focused image corresponds to the first pixel in the first image, and
the collecting data comprises:
in response to the first metric indicating better focus than or as good focus as the second metric, collecting data for the first pixel as data for the third pixel; and
in response to the second metric indicating better focus than the first metric, collecting data for the second pixel as data for the third pixel.

9. A non-transitory computer readable medium storing instructions executable by a computer processor, the instructions comprising functionality for:
acquiring a first image of a sample at a first height of a focal plane;
acquiring a second image of the sample at a second height of the focal plane;
creating a mask from the first image;
calculating a first metric for a first pixel in the first image, wherein the first pixel is not covered by the mask;
calculating a second metric for a second pixel in the second image, wherein the second pixel is not covered by the mask; and
constructing a focused image of the sample from data of the first pixel and data of the second pixel based on the first metric and the second metric.

10. The non-transitory computer readable medium according to claim 9, wherein the instructions further comprise functionality for:
acquiring a plurality of tentative images with a resolution lower that a resolution of either one of the first and second images;
calculating metrics for entireties of the plurality of tentative images; and
selecting the first and second heights based on the metrics.

11. The non-transitory computer readable medium according to claim 9, wherein the creating the mask comprises:
identifying pixels that correspond to an area that is out of interest; and
flagging positions of the identified pixels as positions covered by the mask.

12. The non-transitory computer readable medium according to claim 11, wherein the area that is out of interest is a background.

13. The non-transitory computer readable medium according to claim 9, wherein
the first metric is a first value of Laplacian of Gaussian (LoG) kernel for the first pixel, and
the second metric is a second value of LoG kernel for the second pixel.

14. The non-transitory computer readable medium according to claim 9, wherein the first metric is calculated by accounting only pixels that are in the first image and that are not covered by the mask.

15. The non-transitory computer readable medium according to claim 9, wherein the constructing the focused image comprises:
collecting data for each pixel of the focused image from the first and second images.

16. The non-transitory computer readable medium according to claim 15, wherein
the first pixel in the first image corresponds to the second pixel in the second image,
a third pixel of the focused image corresponds to the first pixel in the first image, and
the collecting data comprises:
in response to the first metric indicating better focus than or as good focus as the second metric, collecting data for the first pixel as data for the third pixel; and
in response to the second metric indicating better focus than the first metric, collecting data for the second pixel as data for the third pixel.
